(19) United States
(12) Patent Application Publication
(10) Pub. No.: US 2005/0185916 A1
(43) Pub. Date: Aug. 25, 2005

(54) Housing case for video setcomprising a video player or game console type electronic console and associated independent display

(76) Inventors: Gilbert Jost, Bettange/Mess (LU); Pascal Albert, Bertrange (LU)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/514,643

(22) PCT Filed: Sep. 11, 2002
(86) PCT No.: PCT/EP02/10189

(30) Foreign Application Priority Data
May 17, 2002 (FR) 02 06103

(51) Int. Cl. H04N 5/781

(52) U.S. Cl. 386/46; 386/125

(57) ABSTRACT

The invention concerns a case (1) consisting of two storage parts (4, 5) mutually secured via a hinge system and provided with means (7) for being removably locked in closed position, that is when they are in contact with each other through their peripheral edge. One of the storage parts (5) is adapted to receive detachably a video screen (3) with its front face visible when the case is in opened position, the other storage part (4) is adapted to receive the electronic console (2) associated with said screen (3) likewise detachably (said console (2) being for example in the form of a DVD video player or a game console). The case further comprises: at least one powering plug-in connection terminating in two removable plug connectors on the screen (3) and electronic console (2), and an internal wiring system provided with detachable plugs for audio-video connection between said electronic console (2) and said associated video screen (3).

The present invention relates to a case-like or bag-like container intended to accommodate a video assembly consisting of an electronic console, such as a DVD, SVCD, VCD player, a games console or the like etc., and ;of the associated independent screen (liquid crystal screen, cathode ray screen, plasma screen, etc.); it also relates to the complete video installation consisting of this case or bag, of the electronic console and of the associated screen.

The structures of cases or bags known hitherto are not truly suitable for accommodating a video assembly of DVD type for example, or the like etc., comprising a first box in the form of an electronic console constituting the player, and a second box constituting the associated screen; and these structures are even less suitable for the implementation of this integrated video assembly, that is to say for the use of the console and video display on the screen accommodated.

The present invention proposes an original accommodating structure in the form of a case or bag especially suited for accommodating an electronic console and its screen, with a view not only to the storage and carriage of this assembly, but also allowing the use of this console with its screen, in an effective and practical manner.

In accordance with the present invention, this case for accommodating an electronic console and video screen is characterized in that it consists of two storage parts secured together by way of a hinge system and furnished with means which allow their removable locking in the closed position, that is to say when they are in contact with one another via their peripheral edge, one of said storage parts is suitable for accommodating the video screen in a removable manner, with its front face visible when the case is in the open position and the other of said storage parts is suitable for accommodating the associated electronic console, likewise in a removable manner. This case furthermore comprises at least one supply connection socket, fashioned on one of said storage parts, from which there runs internal supply wiring terminating at two removable jacks for connection to the screen and to the electronic console, and an internal wiring system furnished with removable jacks for the audio/video link between said electronic console and said screen.

According to a particular embodiment, the storage part for the electronic console comprises an accommodating housing furnished with a removable or partially removable top face, in particular so as to make the use of said console possible once it has been incorporated into its housing.

This top face is preferably made of a flexible material and comprises at least one transparent part so as to render the functional members of the electronic console accessible and actuatable.

According to anther feature, the case comprises a particular compartment for the supply wiring and console/screen link systems. This compartment is fashioned in the part for storing the electronic console, on the hinge system side, behind the housing of said console and is furnished with internal openings or orifices which allow the passage of said wiring systems.

According to another characteristic, the storage part for the screen comprises an inset receptacle for said screen, furnished with removable locking members. This receptacle is preferably fixed to a block of protective material (for example a foam), and this block of material is itself fixed to the casing of the corresponding storage part.

According to yet another feature, the case in accordance with the present invention comprises members for limiting the angle of opening of the two storage parts.

According to a particular embodiment, the case comprises a complementary supply connection socket, as well as audio/video connection sockets, which are linked to the internal wiring systems. This feature allows the supply to the screen removed from the case, or to a second independent screen.

The invention also relates to the video installation consisting of a case as defined above, in one of the storage parts of which is positioned the screen and in the other storage part of which is inserted the electronic console, said case also incorporating at least one supply cable for the linking of the supply connection socket in particular to the mains or to the cigar lighter socket of a motor vehicle, or the like etc., as well as possibly various accessories such as a remote control or an audio headset for example.

According to a particularly beneficial embodiment, within the case of this video installation, the receptacle for removable insetting of the screen is furnished with locking members cooperating with complementary locking members fashioned on said screen.

In a particular embodiment, the case comprises two supply connection sockets and connection sockets for the audio/video link, fashioned on its outer casing, and it incorporates a second independent screen, with an appropriate wiring system suitable for the supply and the audio/video link of this second screen.

However, the invention will be further illustrated, without being in any way limited, by the following description of two particular embodiments, given merely by way of example and represented in the appended drawings in which:

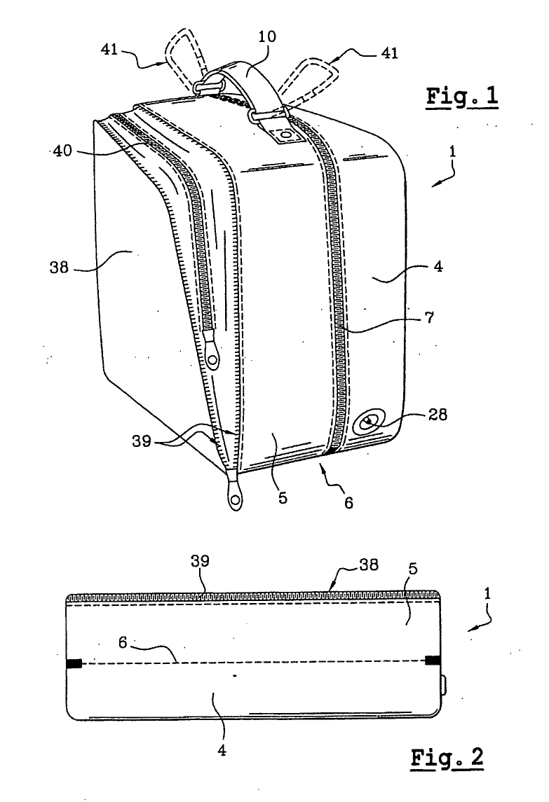

FIG. 1 is a perspective view of a case or bag in accordance with the present invention, illustrated here in the closed position;

FIG. 2 is a view from below of the case illustrated in FIG. 1;

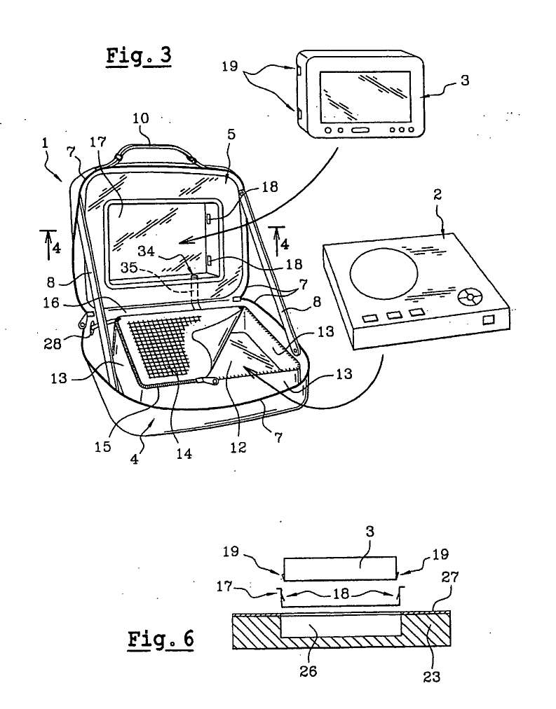

FIG. 3 is a perspective view of the case of FIGS. 1 and 2, illustrated in the open position and equipped with a DVD player, as well as with the associated screen (that are represented removed from the case);

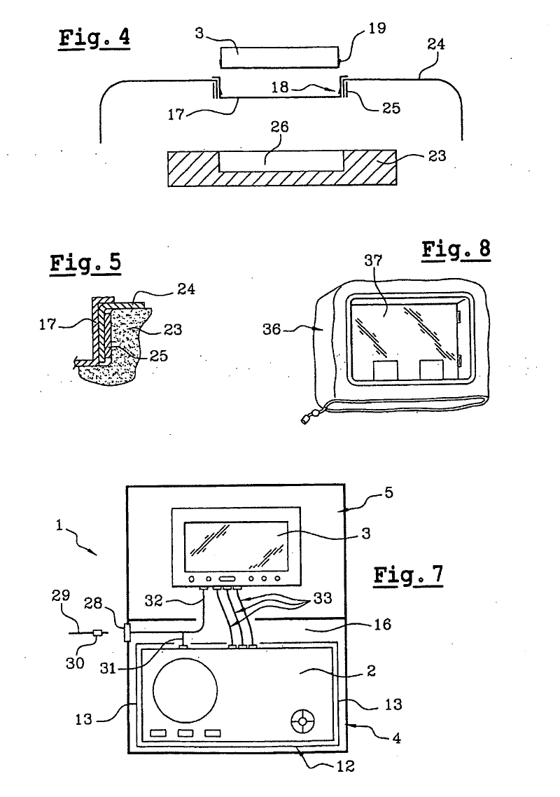

FIG. 4 is a diagrammatic view, in section along 4-4 of FIG. 3 on the part for storing the DVD screen, the various parts being represented exploded;

FIG. 5 is a view of a detail of the principle of fixing the receptacle for insetting the screen to the protective foam block, in accordance with the representation of FIG. 4;

FIG. 6 is a diagrammatic view, again in section, which illustrates another way of fixing the screen receptacle to the foam block, the various parts again being represented exploded;

FIG. 7 is a diagrammatic view of the player/screen link and supply wiring systems incorporated into the case;

FIG. 8 is a perspective view of a screen inset receptacle fixed to a headrest cover, forming a complementary accessory able to be inserted into the case in accordance with the present invention;

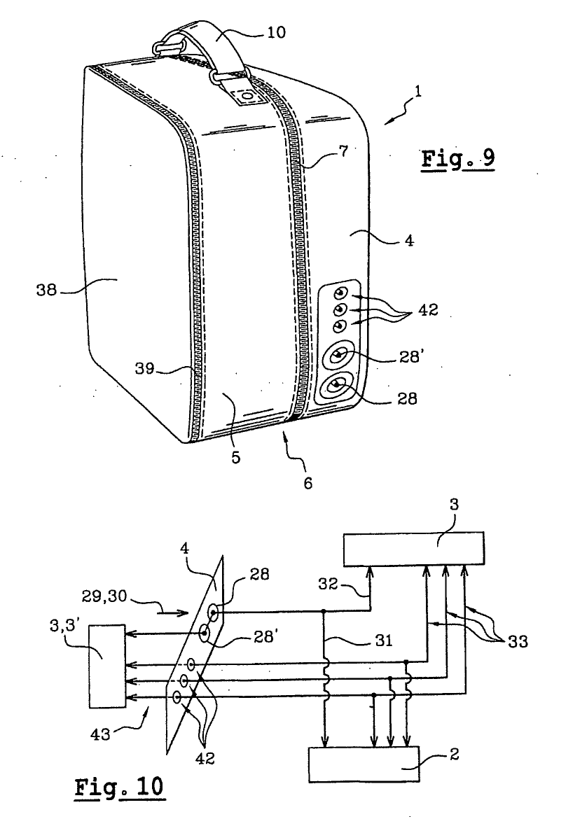

FIG. 9 is a perspective view of another possible embodiment of a case in accordance with the present invention;

FIG. 10 is a diagrammatic view of the player/screen link and supply wiring systems of the case illustrated in FIG. 9.

The case or bag 1 illustrated in FIGS. 1 to 7 allows the storage of an electronic console 2 and of a screen 3, which here take the form of a DVD player and of a screen; it also incorporates internal prewiring intended for the electrical link between the player 2 and the screen 3, with a view to the viewing of DVD video discs.

This case or bag 1 comprises two storage parts 4 and 5 of parallelepipedal general shape, linked by a hinge system 6 at the level of the bottom zone, and furnished with a glide closure system 7 on the other three sides of their peripheral edge, that is to say on the lateral sides and on the front part.

The glide closure 7 allows removable locking of the two storage parts 4 and 5 in the closed position (FIGS. 1 and 2), that is to say when said storage parts 4 and 5 are in contact with one another via their peripheral edge. When the case is open, the angle of opening of these two storage parts 4, 5 is limited by the presence of two lateral flexible tabs 8, visible in FIG. 3; these two flexible tabs 8 may be adjustable lengthwise and they may be fixed to the storage parts 4 and 5 in a removable manner, for example by way of press-button systems.

The external casing of the two storage parts 4 and 5 may be made of a flexible material, of the woven, plastic or leather kind for example, associated with a thickness of foam or other material making it possible to absorb shocks.

In a derived embodiment, this casing may take the form of rigid shells secured by a hinge system, and furnished with one or more closure clips on the side opposite from said hinge.

In FIGS. 1 and 3, it is noted that the case is equipped with a gripping handle 10 fashioned on the front part, that is to say on the side opposite from the hinge 6. In the exemplary embodiment illustrated, the handle 10 is fixed on the storage part 5 which has a slightly greater thickness than that of the storage part 4.

The inner face of the storage part 4 is fashioned so as to accommodate the console 2 in the form of a DVD player.

This storage part 4 incorporates for this purpose a housing 12 which occupies a large part of the available volume, and which is delimited by a ring of lateral walls 13 and by a top face 14.

The lateral walls 13 are made of a flexible material, for example woven or synthetic; they may be secured with the casing of the storage part 4 by means of stitches or by gluing. Certain at least of these lateral walls 13 are preferably disposed slightly set back with respect to the sides of the casing of the storage part 4 so as to effectively protect the electronic console 2.

The top face 14 is secured to the upper edge of the lateral walls 13. On the front part and the lateral sides, this securing is achieved by way of a glide closure 15 so as to allow the incorporation of the DVD player 2 into the housing 12, and its removal.

This top face 14 is also made of a flexible material of woven or synthetic kind; preferably it comprises a transparent part (plastic material or net-like structure), or it is made wholly of a transparent material, so as to allow the actuation of the functional tactile buttons of the console 2 when said console is placed in its housing 12.

As seen previously, a bigger or smaller space is preserved between the sides of the storage part 4 and the ring of walls 13; this space defines especially a particular compartment 16 in the bottom of the case, hinge 6 side, whose function will be explained later.

The internal face of the storage part 5 is fashioned so as to accommodate the DVD screen 3, in particular in such a way that the front face of this screen is visible when the case is in the open position (FIG. 3).

For this, and in the exemplary embodiment illustrated, the storage part 5 comprises a receptacle 17 in the form of a box, which is suitable for ensuring effective holding of the screen 3 by removable insetting. The dimensions of the receptacle 17 are suited to those of the screen 3; and this receptacle 17, as well as the screen 3 comprise complementary latching members 18, 19 allowing the removable locking of said screen 3 once it is inset into said receptacle 17.

The latching members 18, 19 are fashioned on the sides of each element; the removal of the screen 3 from the receptacle 17 can be performed by deactivating these latching members, for example by means of very thin cards inserted between the two elements.

The inset receptacle 17 is advantageously fixed in the storage part 5 on a block of protective material 23 (for example a block of foam), this being done by way of a hood 24, in the manner illustrated in FIGS. 4 and 5.

As may be seen in these two figures, the receptacle 17 is fixed on the rim of an opening fashioned in the hood 24 by way of a clamping collar or band 25. It is also conceivable to effect this fixing by simple gluing.

The receptacle 17 thus equipped will be housed in a reservation 26 of suitable parallelepipedal general shape, fashioned in the block of foam 23, and the hood 24 is fixed on the sides and/or on the top face of this block of foam, for example by gluing, so as to obtain an esthetic finish. The material of the hood 24 (leather, woven, synthetic or the like) is chosen in particular as a function of the desired visual finish.

The foam block 23 equipped with the inset receptacle 17 and with the hood 24 is fixed by any appropriate means to the interior of the casing of the storage part 5, in particular by gluing.

As illustrated in FIG. 6, in a variant embodiment, the top face of the foam block 23 can accommodate a finishing trim 27, fixed for example by gluing; and the box 17 for accommodating the screen 3 may be simply fixed by gluing or incorporated by force-fitting into the reservation 26 of the foam block 23.

The electrical connections allowing the operation of the video assembly (player +DVD screen) incorporated into the case 1 are detailed in FIG. 7.

In this figure, one notes the presence of a supply connection socket 28 fixed on the external casing of the case, and in particular for the embodiment illustrated, fixed on the storage part 4, opposite the compartment 16. This supply connection socket 28, also visible in FIG. 1, allows the installation to be plugged into the mains or into the cigar lighter socket of a motor vehicle, by means of a connection cable 29 furnished with a suitable removable jack 30.

The incorporated wires 31 and 32 which provide for the supply respectively to the DVD player 2 and to the DVD screen 3 run from the connection socket 28. These two wires 31 and 32 are furnished at their free end with a removable connection jack whose type is suited to the apparatus connected.

Moreover, the player 2 and the screen 3 are linked by various wires 33 intended to ensure the audio/video link (in particular a video wire and two right/left audio wires), furnished at each of their ends with removable jacks of suitable type.

According to a beneficial embodiment, the four wires for connection to the screen 3 may be brought together to terminate at one and the same jack (of RCA or DC or similar type) intended to be plugged into an appropriate connection facility of said screen.

The various wires 31, 32 and 33 pass through the bottom compartment 16; they then run through appropriate openings or orifices fashioned in the ring of walls 13, in the casing 24, in the block of foam 23 and in the box 17, and arrive at the corresponding kit. In FIG. 3 in particular, one notes the orifice 34 provided in the receptacle 17 and the channel 35 fashioned in the foam block 23 to ensure the supply to the DVD screen 3.

In the compartment 16 the various wires may be masked by a removable flap, for example held by a system of self-adhesive strips.

The case in accordance with the present invention advantageously incorporates a plurality of accessories allowing or facilitating the implementation of the video installation, namely:
a 12-volt supply cable with cigar lighter socket,
a supply cable with mains socket, furnished with a transformer (12 volts/220 volts),
headphones, and
a headrest cover 36 together with a screen box 37, such as is illustrated in FIG. 8.

This headrest cover 36, equipped with a screen receptacle 37 similar to the receptacle 17 described previously, allows the DVD screen 3 to be accommodated and positioned on the rear face of a headrest, with a view to the viewing of a DVD disc from the rear seats of a vehicle, after the necessary plugging in of the supplies.

These various accessories are stored in the available spaces of the case, namely around the housing 12, between the two storage parts 4 and 5, or else in one or more complementary pouches fashioned in the external casing.

As illustrated in FIGS. 1 and 2, a complementary pouch 38 in the form of a bellows-type pouch may be fashioned over the whole external surface of one of the storage parts 4, 5. This pouch 38 may be deployed by way of a glide closure 39, and it comprises its own opening/closing system, again of the glide closure kind 40.

Represented dashed in FIG. 1 are two snap-clasps 41, fixed to the handle 10 of the case; these snap-clasps 41 allow in particular the fastening of the case onto the anchoring rods of a seat headrest of a motor vehicle, or the like.

Represented in FIGS. 9 and 10 is another possible embodiment of the case in accordance with the present invention.

In this embodiment, the case comprises all of the equipment and hookups of the embodiment described previously, and in addition its external casing is equipped with a complementary supply connection socket 28′, and also with audio/video connection sockets 42, to allow supply from outside either of the video screen 3 removed from the receptacle 17, or of a second separate and independent screen 3′.

As may be seen in FIG. 10, the two supply connection sockets 28 and 28′ are linked together electrically (and the supply wires 31 and 32 run internally from one or other of these connection sockets); moreover, each audio/video connection socket 42 is linked electrically in an appropriate manner with one of the incorporated audio/video wires 33.

An appropriate wiring system 43, consisting of a supply wire and of audio/video connection wires, is provided to ensure the external supply of the video screen 3 or 3′.

The two embodiments described of cases allow optimized accommodation of an electronic console and of the associated screen. The video installation obtained is very simple and very practical to implement, anywhere that has an appropriate electrical power supply. This case is especially adapted for the accommodation of a DVD player with its screen, but in the same manner, it may be equipped with any other type of video assembly, for example a games console with screen.

1. A case for accommodating a video assembly comprising an electronic console (2), of the video player or games console kind, and the an associated independent screen (3), wherein the case comprises two storage parts (4, 5) secured together by way of a hinge system (6) and furnished with a closure (7), one of said storage parts (5) being suitable for accommodating said screen (3) in a removable manner, with its front face visible when the case is in the open position and the other of said storage parts (4) being suitable for accommodating said associated electronic console (2) in a removable manner, said case further comprising at least one supply connection socket (28), fashioned on one of said storage parts (4, 5), from which there runs internal supply wiring (31, 32) terminating at two removable jacks for connection to said screen (3) and to said console (2), and an internal wiring system (33) furnished with removable jacks for the audio/video link between said console (2) and said screen (3).

2. The case as claimed in claim 1, wherein the storage part (4) for the electronic console (2) comprises an accommodating housing (12) furnished with a top face (14) which is at lest partially removable so as to make the use of said console (2) possible once it has been incorporated into its housing (12).

3. The case as claimed in claim 2, wherein the top face (14) of the housing (12) for accommodating the electronic console (2) is made of a flexible material and comprises at least one transparent part so as to render the functional members of said console (2) accessible and actuatable.

4. The case as claimed in claims 1, wherein the case comprises a compartment (16) for the supply wiring (31, 32) and console/screen link (33) systems, said compartment (16) being fashioned in the part (4) for storing the electronic console (2), on the hinge system (6) side, behind the housing (12) of said console (2) and which compartment (16) is furnished with openings or orifices allowing the passage of said wiring systems (31, 32, 33).

5. The case as claimed in claims 1, wherein the storage part (5) for the screen (3) comprises an inset receptacle (17) for said screen (3), furnished with removable locking members (18).

6. The case as claimed in claim 5, wherein the receptacle (17) for removable insetting of the screen (3) is fixed to a block of protective material (23), which block of material (23) is itself fixed to the casing of the corresponding storage part (5).

7. The case as claimed in claims 1, wherein it comprises members (8) for limiting the angle of opening of the two storage parts (4, 5).

8. The case as claimed in claims 1, wherein it comprises a complementary supply connection socket (28′), as well as audio/video connection sockets (42), which sockets (28′ and 42) are linked to the internal wiring systems (31, 32, 33), for the external supply of a screen (3, 3′).

9. A video installation comprised of a case (1) as claimed in claims 1, in one of the storage parts (5) of which is positioned the screen (3) and in the other storage part (4) of which is inserted the electronic console (2), said case (1) also incorporating at least one supply cable (29, 30) for the linking of the supply connection socket (28) in particular to the mains or to the cigar lighter socket of a motor vehicle.

10. The video installation as claimed in claim 9, wherein it comprises a case (1) comprising a removable inset receptacle (17) for the screen (3), which receptacle (17) is furnished with removable locking members (18) cooperating with complementary locking members (19) fashioned on said screen (3).

11. The video installation as claimed in claim 9, wherein it comprises a case as claimed in claim 8 and a wiring system (43) appropriate for the external supply of a screen (3, 3′).
